(19) United States
(12) Patent Application Publication
(10) Pub. No.: US 2002/0126814 A1
(43) Pub. Date: Sep. 12, 2002

(54) Apparatus, method and computer program product for automatic directory entry generation via caller-id

(75) Inventors: Faisal M. Awada, Round Rock, TX (US); Joe Nathan Brown, Austin, TX (US); Herman Rodriguez, Austin, TX (US)

Correspondence Address: Duke W. Yee, Carstens, Yee & Cahoon, LLP, P.O. Box 802334, Dallas, TX, 75380, US

(73) Assignee: International Business Machines corporation, Armonk, NY (US)

(21) Appl. No.: 09/801,618

(22) Filed: Mar. 8, 2001

(51) Int. Cl. H04M 1/64; H04M 11/00; H04M 15/06

(52) U.S. Cl. 379/142.01; 379/88.21; 379/93.23

(57) ABSTRACT

An apparatus, method and computer program product for automatically generating directory entries based on caller-id information are provided. When a call is received from a calling party, the caller-id information is obtained from a caller-id database. Either before, during or after the communication connection is established between the calling party's communication device and the called party's communication device, the called party is given the option to store and/or update the caller-id information as a directory entry in a local directory of the called party's communication device. If the called party elects to have the calling party's caller-id information stored in the called party's directory, the caller-id information is transmitted to the called party's communication device and stored as an entry in the called party's local directory and is used for further processing such as call block and the like. The caller-id information stored in the party's local directory may be more than the caller-id information displayed on the communication device display.

### BACKGROUND OF THE INVENTION

1. Technical Field

The present invention is directed to an apparatus, method and computer program product for automatic directory entry generation via caller-id. More specifically, the present invention is directed to an apparatus, method and computer program product to build a personal directory from caller-id information obtained when calls are received.

2. Description of Related Art

The use of caller-id devices has become a well established standard to telephones. With caller-id, a telephone number of a calling party and their name are displayed on a display associated with a telephone terminal of a called party. In some systems, the name of the calling party is obtained from a centralized database while with others, such as with mobile telephones, the name of the calling party is only displayed if the calling party telephone number is present in a directory associated with the telephone terminal.

In addition to caller-id devices, stored directories are fast becoming a standard in telephone devices. These directories store telephone numbers and associated party names in a memory associated with the telephone terminal. A party may access the directory through the telephone terminal and select an entry from the directory in order to automatically launch a call or e-mail to the party designated by the directory entry.

The prior art directories as described above are limited in that they can only be generated by having the user of the telephone terminal enter the directory information directly using the keypad of the telephone terminal or by downloading via cable or infrared connection from a personal computer or personal digital assistant. There is no automatic mechanism for storing or updating directory information.

Moreover, directory entry information may become stale, such as when a party moves or changes contact information, e.g. when a mailing address, telephone number, electronic mail address, or the like changes. The prior art directory systems do not provide a mechanism by which stale directory entries may be updated automatically.

Thus, it would be beneficial to have an apparatus, method and computer program product for automatically generating and/or updating directory entries.

### SUMMARY OF THE INVENTION

The present invention provides an apparatus, method and computer program product for automatically generating directory entries based on caller-id information. With the present invention, when a call is received from a calling party, the caller-id information is obtained from a caller-id database. Either before, during or after the communication connection is established between the calling party's communication device and the called party's communication device, the called party is given the option to store the caller-id information as a directory entry in a local directory of the called party's communication device. If the called party elects to have the calling party's caller-id information stored in the called party's directory, the caller-id information is transmitted to the called party's communication device and stored as an entry in the called party's directory, which may be local to the called party's communication device.

The caller-id information stored in the party's local directory may be more than the traditional caller-id information displayed on the communication device display. That is, the amount of caller-id information that may be displayed on the communication device display may be limited to only the address of the calling party's communication device and/or the name of the calling party. However, the caller-id information stored in the local directory may include, for example, the calling party's communication device address, the name of the calling party, the calling party's mailing address, electronic mail address, facsimile number, the geographical location of the calling party, the business category yellow pages information for the calling party, a birthday date, an anniversary date, and any other personal information of the calling party. Other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram illustrating a network data processing system according to the present invention;

FIG. 2 is an exemplary diagram illustrating a message flow according to the present invention;

FIG. 3 is an exemplary block diagram illustrating a local directory entry in accordance with the present invention;

FIG. 4 is an exemplary block diagram illustrating a display of a communications device in accordance with the present invention; and

FIG. 5 is a flowchart outlining an exemplary operation of the present invention.

### DETAILED DESCRIPTION OF THE PREFERRED EMBODIMENT

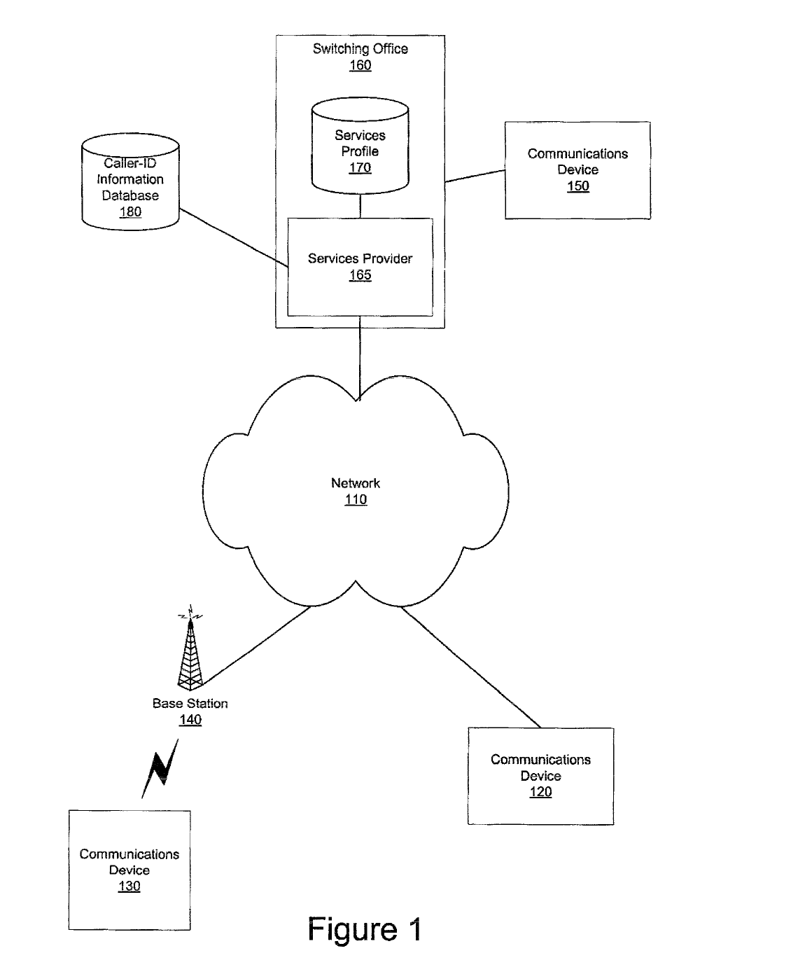

FIG. 1 is an exemplary block diagram illustrating a network data processing system in accordance with the present invention. As shown in FIG. 1, the network data processing system includes a plurality of communication devices 120, 130 and 150 coupled to at least one network 110. The communication devices 120, 130 and 150 may be any type of communication device that is capable of sending and receiving communication signals/data over the at least one network 110. For example, the communication devices 120, 130 and 150 may be wired or wireless telephones, computers, personal digital assistants, cellular telephones, and the like.

Communications device 130 represents a wireless communication device that communicates over the at least one network 110 via one or more base stations 140. The wireless communication link between the communications device 130 and the one or more base stations 140 may be, for example, a radio communication link, such as a cellular telephone communication link, a satellite communication link, an infrared communication link, any combination of the above, and the like. The communication device 130, in the following exemplary embodiments, will be considered to be a mobile telephone.

Communications device 120 represents a wired communications device that is coupled to the at least one network 120 via wired means. Such wired means may be, for example, conventional telephone lines, fiber optic lines, co-axial cable lines, Digital Subscriber Lines (DSL), any combination of the above, and the like. For purposes of the following description, it will be assumed that the communication device 120 is a wired telephone coupled to the network 110 via a conventional telephone line.

The at least one network 110 may be any type of network capable of conveying communication signals/data to and from communication devices. The at least one network 110 may include, for example, a public switched network, such as conventional telephone network, a cellular telephone network, a satellite network, a data network, and the like. For purposes of the following description of the exemplary embodiments, the network 110 will be considered to be a conventional telephone network.

The communications device 150 is coupled to the network 110 via a switching office 160. The switching office 160 may be, for example, a public switch in a conventional telephone network, such as an SS7 switch, a service provider, such as an Internet Service Provider (ISP), a router, a computing device, or the like. For purposes of the following description, it will be assumed that the switching office 160 is a public switch.

The switching office 160 is equipped with a services provider 165 and a services profile storage device 170. The services provider 165 may be embodied as hardware, software, or a combination of hardware and software. For example, the services provider 165 may be software instructions executed by one or more processors associated with the switching office 160. The services profile storage device 170 may be a memory, hard disk, removable medium, magnetic tape, or the like, upon which data may be stored. The services profile storage device 170 may be integrated with the switching office 160, locally coupled to the switching office 160, or remotely located from the switching office 160 but accessible to the switching office 160 via communication links, such as network 110.

The services provider 165 may provide one or more services to communication devices that are registered with the services provider 165. In particular, the services provider 165 provides an automatic directory service, in accordance with the present invention, to communication devices that have registered with the services provider 165.

Communication devices may register with the services provider 165 by subscribing to services provided by the services provider 165. The various services to which a particular communication device subscribes are listed in a profile for the communication device stored in the services profile storage device 170. Thus, when a communication is received for a communication device, such as communication device 150, the address, e.g. the telephone number, for the communication device 150 is looked-up in the services profile storage device 170 and a corresponding profile is retrieved. The services provider 165, based on the retrieved profile, determines which services to provide to the communications device 150. Thus, if the communications device 150 subscribes to the automatic directory service of the present invention, an indication of this subscription is present in the communication device 150 profile. Based on the presence of the automatic directory service identifier in the profile for communication device 150, the services provider 165 executes instructions to provide the automatic directory service to the communications device 150, in a manner described hereafter.

When a call is initiated, for example, from communications device 130 destined from communications device 150, the communication signal is routed through switching office 160. The communication signal includes data having an identifier of the calling party communication device 130 and an identifier of the called party communication device 150. Based on this information, the service provider 165 of the switching office 160 searches the services profile storage device 170 for a profile corresponding to the called party communication device identifier. Based on the profile for the communication device 150, the services provider 165 determines that the communication device 150 subscribes to the automatic directory service.

As a result of the determination that the communication device 150 subscribes to the automatic directory service, the services provider 165 retrieves caller-id information from the caller-id information database 180. The caller-id information retrieval from the caller-id information database 180 is based on the calling party identifier included in the communication signal from the communication device 130. The caller-id information may include any type of information that may be appropriate for inclusion in a directory. For example, the caller-id information retrieved may include the calling party communication device address (e.g., telephone number) and one or more of the calling party name, mailing address, facsimile number, electronic mail address, business address, geographical location information, birthday, anniversary, and the like.

The services provider 165 may then provide the caller-id information retrieved from the caller-id database 180, or a portion thereof, to the called communication device 150. The communication device 150 may then display this caller-id information using an associated display device such that a user of the communications device 150 may make use of this information. In addition to the caller-id information being displayed on the communications device 150, options to store the caller-id information in a local directory may also be provided. For example, the communications device 150 may display options to add the caller-id information to a directory associated with the communication device 150, not to add the caller-id information to the directory, add the calling party communication device identifier to a call block list, or to send the caller-id information as an address file to the called party's electronic mail address, as will be discussed hereafter.

A user of the communication device 150 may select one of these options by inputting a selection via an input interface of the communications device 150. For example, the user may press an appropriate button on the keypad of the communications device 150 that is associated with a particular option that the user wishes to select. In response to receiving the input from the user, a selection signal is returned to the services provider 165.

Based on receipt of the selection signal from the communications device 150, the services provider performs an appropriate operation corresponding to the selection of the user. If the user selected to add the caller-id information to a local directory for the communications device 150, the caller-id is properly formatted into a local directory entry and added to a local directory associated with the communications device 150. This local directory may be a directory stored in the switching office 160, in the communications device 150, or in a remotely located storage device (not shown) that is accessible by the communications device 150. The caller-id information that is formatted and stored in the local directory may include additional caller-id information than the caller-id information presented to the user of the communications device 150.

For example, the caller-id information presented to the user of the communications device 150 may comprise the calling party communication device address and the name of the calling party. However, the caller-id information stored in the local directory may include this information as well as a mailing address, facsimile number, electronic mail address, business address, birthday, anniversary, and the like, of the calling party.

If the user selects not to add the caller-id information to the local directory, the services provider 165 does not reformat the caller-id information or store it in the local directory. If the user selects to add the communication device identifier to a call block list, the services provider 165 adds the address, e.g., the telephone number, or the communication device 130 to a call block list associated with the communications device profile. The call block list may be used to filter out calls that are received for the communications device 150. If a call is received from a communications device whose address is in the call block list, the call is not allowed to continue to the communication device 150. Instead, a busy signal, call reject signal, call block signal, or other message indicating the inability to complete the call is returned to the calling communication device.

If the user selects to have the caller-id information forwarded to his/her electronic mail address, the caller-id information may be reformatted for use with an address book of an electronic mail program, attached to a standardized electronic mail message, and sent to the user's electronic mail address. The user's electronic mail address, as well as an indicator of the user's preferred electronic mail program, may be obtained from the communication device profile retrieved from the services profile storage device 170, for example. The attached caller-id information may then be imported into the user's electronic mail address book for later use.

In order to provide the electronic mail functionality described above, the services provider 165 must be able to transmit electronic mail messages. This requires the services provider 165 to have access to a network adapter and an electronic mail program. The services provider 165 may then transmit the electronic mail message with the attached caller-id information via the network adapter over the network 110 to a user's electronic mail server, in a manner generally known in the art.

Thus, the present invention provides a mechanism by which a local directory for a communications device may be automatically established and updated based on caller-id information retrieved for calling party communication devices. The present invention further provides the ability to generate and update a call block list and/or an electronic mail address book based on caller-id information. For example, a call may be received over a conventional telephone and the caller-id information associated with that call may be electronically mailed to a user's electronic mail address for use with a computer.

While the above embodiment of the present invention has been described in terms of the service provider 165 and the services profile storage device 170 being associated with a switching office 160, the present invention is not limited to such an architecture. Rather, the services provider 165 and services profile storage device 170 may be separate devices from the switching office 160 that are accessible via the network 110. In addition, the services provider 165 and the services profile 170 may be incorporated into the communications device 150.

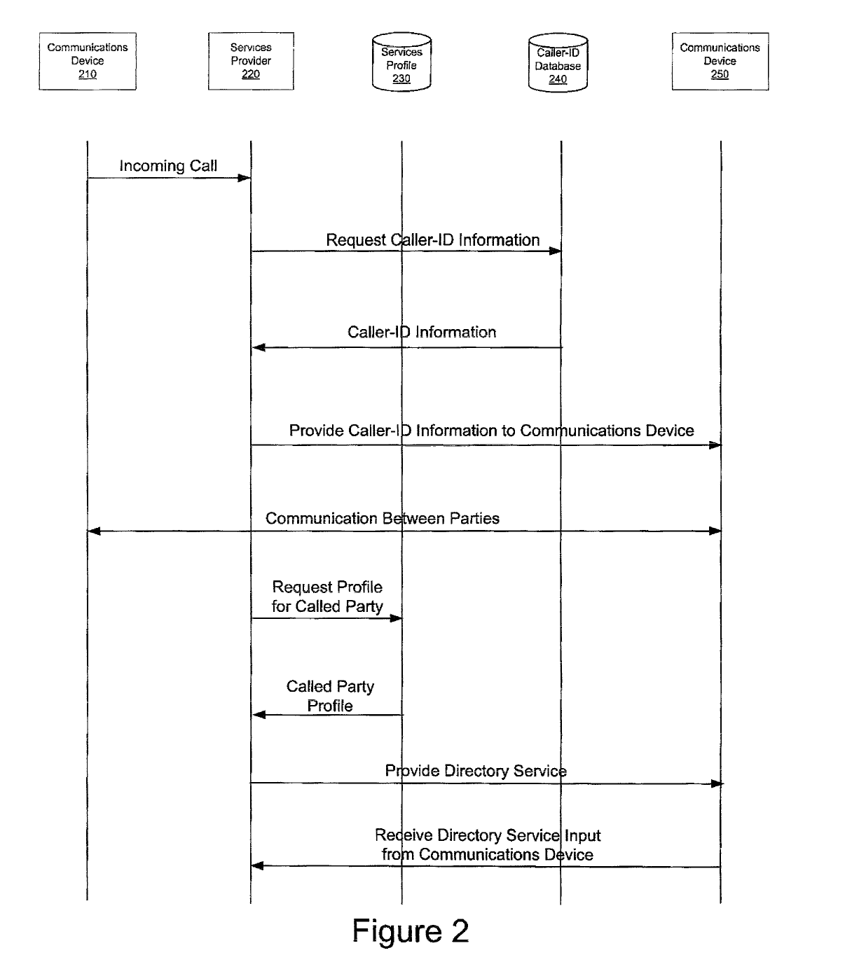

FIG. 2 is an exemplary flow diagram illustrating the message flow according to one exemplary embodiment of the present invention. As shown in FIG. 2, the message flow starts with an incoming call from a calling communications device 210 to the services provider 220. The services provider 220 requests caller-id information from the caller-id database 240 for the calling party communications device 210. The caller-id information for the calling party communications device 210 is then returned to the services provider 220.

The caller-id information, or a portion thereof, is then provided to the called party communications device 250 and communication between the parties is established. During or after the communication between the parties, the services provider 220 requests profile information for the called party from the services profile storage device 230. The called party profile information is then returned to the services provider 220 and automatic directory service is provided to the called party communication device 250 in the manner described above. This may include updating a local directory, updating a call block list, and/or sending caller-id information to an electronic mail address associated with the called party.

The message flow shown in FIG. 2 assumes that the automatic directory service is provided to the called communications device 250 either during or after the communication between the parties is established. The present invention, however, is not limited to such and the automatic directory service may be provided prior to establishing communication between the parties.

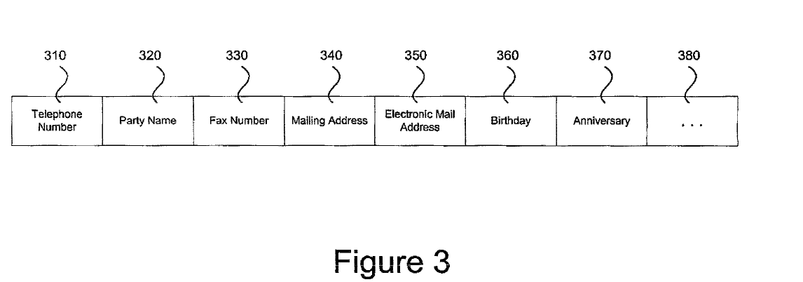

FIG. 3 is an exemplary block diagram illustrating a local directory entry in accordance with the present invention. The local directory entry contains information fields 310-380 that include various information about the calling party. The field 310 provides a telephone number of the calling party. Field 320 contains the calling party name, field 330 contains the facsimile number of the calling party, field 340 contains the mailing address of the calling party, field 350 contains the birthday date of the calling party, field 370 contains the anniversary date of the calling party, and field 380 contains any other information that may be appropriate for inclusion in a directory.

As mentioned above, this directory entry contains more information than is typically displayed to a called party as part of a caller-id service. The called party may only be provided with the information in fields 310 and 320 when the call is forwarded to the called party communication device. However, when the caller-id information is reformatted and added to a local directory for the called party communication device, more than only fields 310 and 320 may be populated.

The local directory established in the manner described above with regard to the present invention may be accessed by the user's communication device for later use. For example, the user may press a button on the communication device, dial an access number for the switching office, dial an access number for a local directory storage device access service, enter an address for the directory storage device access service, or the like. The user may then be provided with all of the information stored in the directory entries of the user's local directory. Such information may be displayed in any manner deemed feasible, such as in a scrolling list, as pages of an address book, or the like, depending on the capabilities of the user's communication device.

Furthermore, the user may sequentially select a directory entry and a transmit button to thereby automatically launch a communication with the communication device associated with the directory entry. Such automatic launching of a communication may include, for example, dialing the telephone number listed in field 310, generating a blank electronic mail message directed to the address listed in field 350, and the like.

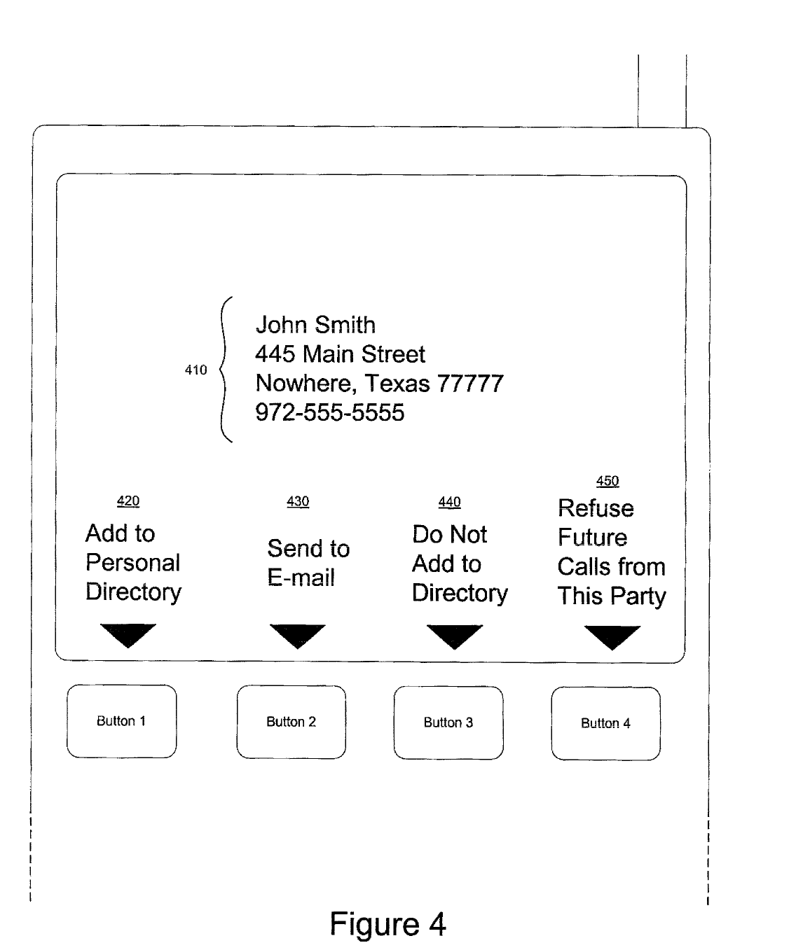

FIG. 4 is an exemplary diagram of a caller-id display on a communication device 400 in accordance with the present invention. As shown in FIG. 4, the display includes the caller-id information 410 as well as one or more options 420-450 for use with the caller-id information. The communications device 400 shown in FIG. 4 resembles a wireless telephone, however the invention is not limited to wireless telephone displays.

The caller-id information 410, as mentioned above, may include all or a portion of the caller-id information retrieved from the caller-id database. In the particular example shown in FIG. 4, the caller-id information 410 includes the name, address, and telephone number of the calling party.

The options 420-450 provided to the user of the communications device 400 may include to add the caller-id information to a local personal directory 420, send the caller-id information to the user's electronic mail address 430, do not add the caller-id information to the user's local personal directory 440, or refuse future calls from this calling party 450. The various options may be selected by a user of the communication device 400 by depressing one of the buttons (button 1-4) which are associated with the various options. The user's selection is then transmitted to the services provider (if the services provider is remote from the communication device 400) and appropriate processing by the service provider is performed in the manner previously described.

The above-described process may be used to update directory listings in the called party's directory in addition to generating new listings in the called party's directory. In order to perform an update function, the present invention may search the called party's directory to determine if an entry corresponding to one or more portions of the caller-id information already exists. For example, the present invention may compare calling party names, calling party mailing addresses, email addresses, or the like to entries already present in the called party's directory to determine if a corresponding entry already exists.

If a corresponding entry already exists, the user may be provided with an option to replace the existing entry or discard the new caller-id information. If the user selects to replace the existing entry, the fields of the existing entry are replaced with values obtained from the newly received caller-id information. If the user selects to discard the changes, the directory entry is not updated.

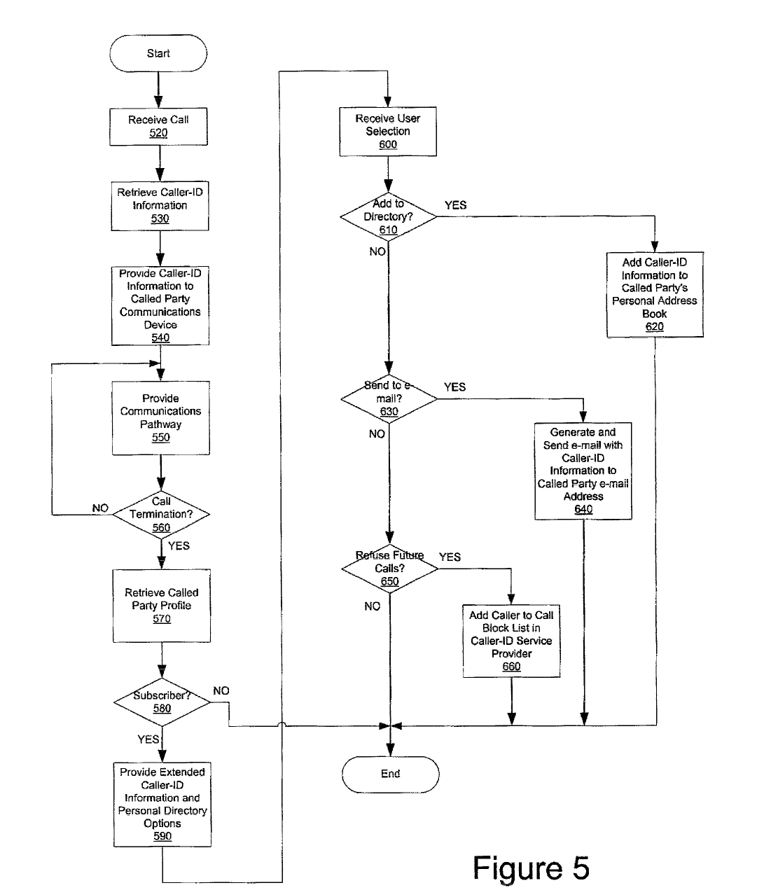

FIG. 5 is a flowchart outlining an exemplary operation of one embodiment of the present invention. The steps shown in FIG. 5 need not be performed in the specific order shown and may be rearranged as deemed fit by the specific application of the present invention.

As shown in FIG. 5, the operation starts with a call being received (step 520). The caller-id information is retrieved (step 530), provided to the called party communications device (step 540) and a communications pathway between the called party communications device and the calling party communications device is established (step 550).

A determination is made as to whether the call has terminated (step 560). If not, the operation returns to step 550 and the call continues. If the call is terminated, the called party profile is retrieved (step 570) and a determination is made as to whether the called party is a subscriber to the automatic directory service (step 580). If the called party is not a subscriber, the operation ends. If the called party is a subscriber, the caller-id information and personal directory options are provided to the called party (step 590).

A personal directory option selection is then received from the user, i.e. the called party (step 600). A determination is made as to whether the selected option is to add the caller-id information to the called party personal directory (step 610). This option, in one embodiment, may include updating an existing entry in a called party directory, for example, as described above. In such an embodiment, a check of the directory entries to determine if an entry corresponding to newly received caller-id information is present in the directory, is made prior to providing the user with an option to add the caller-id information to the called party personal directory.

If the user selects to add the caller-id information to the called party's personal directory, the caller-id information is added to the called party's personal directory (step 620) and the operation ends. If not, a determination is made as to whether the selected option is to send the caller-id to the called party's electronic mail address (step 630). If so, an electronic mail message is generated and the caller-id information is attached thereto and sent (step 640).

If the selected option is not to add the caller-id information to the called party's personal directory or to send the caller-id information to the called party's electronic mail address, a determination is made as to whether the selected option was to refuse future calls from the calling party (step 650). If so, the calling party identifier is added to a call block list (step 660). Thereafter, or if the selected option is not to refuse future calls from the calling party, the operation ends (i.e. Continue with phone menu system if appropriate).

Thus, the present invention provides a mechanism to automatically create a personal directory for subscribers as well as update the personal directory of those subscribers. Furthermore the present invention provides a mechanism by which a subscriber may add a calling party to a call block list, to thereby filter out and refuse calls from the calling party, and/or add the calling party caller-id information to an electronic mail address book for later use.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of generating a directory entry for a calling party in a personal directory associated with a called party, comprising:
receiving a call from a calling device;
obtaining caller-id information for a calling party associated with the calling device; and
adding the caller-id information to the personal directory of the called party.

2. The method of claim 1, further comprising:
providing a portion of the caller-id information to a user of a called device; and
providing a first selectable option for adding the caller-id information to the personal directory of the called party.

3. The method of claim 2, wherein the caller-id information is added to the personal directory of the called party in response to receiving a selection of the first selectable option.

4. The method of claim 2, further comprising:
providing a second selectable option for not adding the caller-id information to the personal directory of the called party; and
not adding the caller-id information to the personal directory of the called party in response to receiving a selection of the second selectable option.

5. The method of claim 2, further comprising:
providing a second selectable option for sending the caller-id information to an electronic mail address of the called party; and
sending the caller-id information to the electronic mail address of the called party in response to receiving a selection of the second selectable option.

6. The method of claim 2, further comprising:
providing a second selectable option for adding the caller-id information to a call block list; and
adding the caller-id information to the call block list in response to receiving a selection of the second selectable option.

7. The method of claim 1, further comprising:
retrieving a profile for the called party; and
determining if the called party subscribes to an automatic directory service, wherein the step of adding the caller-id information to the personal directory of the called party is performed only if the called party subscribes to the automatic directory service.

8. The method of claim 1, wherein the method is performed in a services provider of a switching office in a telecommunications network.

9. The method of claim 8, wherein the caller-id information is obtained from a caller-id database that is remotely located with respect to the switching office.

10. The method of claim 1, wherein the method is performed in a communications device local to the called party.

11. The method of claim 1, wherein the caller-id information includes one or more of a calling party's communication device address, a name of the calling party, a calling party's mailing address, a calling party's electronic mail address, a calling party's facsimile number, a geographical location of the calling party, business category yellow pages information for the calling party, a birthday date of the calling party, and an anniversary date of the calling party.

12. An apparatus for generating a directory entry for a calling party in a personal directory associated with a called party, comprising:
means for receiving a call from a calling device;
means for obtaining caller-id information for a calling party associated with the calling device; and
means for adding the caller-id information to the personal directory of the called party.

13. The apparatus of claim 12, further comprising:
means for providing a portion of the caller-id information to a user of a called device; and
means for providing a first selectable option for adding the caller-id information to the personal directory of the called party.

14. The apparatus of claim 13, wherein the caller-id information is added to the personal directory of the called party in response to receiving a selection of the first selectable option.

15. The apparatus of claim 13, further comprising:
means for providing a second selectable option for not adding the caller-id information to the personal directory of the called party; and
means for not adding the caller-id information to the personal directory of the called party in response to receiving a selection of the second selectable option.

16. The apparatus of claim 13, further comprising:
means for providing a second selectable option for sending the caller-id information to an electronic mail address of the called party; and
means for sending the caller-id information to the electronic mail address of the called party in response to receiving a selection of the second selectable option.

17. The apparatus of claim 13, further comprising:
means for providing a second selectable option for adding the caller-id information to a call block list; and
means for adding the caller-id information to the call block list in response to receiving a selection of the second selectable option.

18. The apparatus of claim 12, further comprising:
means for retrieving a profile for the called party; and
means for determining if the called party subscribes to an automatic directory service, wherein the step of adding the caller-id information to the personal directory of the called party is performed only if the called party subscribes to the automatic directory service.

19. The apparatus of claim 12, wherein the apparatus is part of a services provider of a switching office in a telecommunications network.

20. The apparatus of claim 19, wherein the caller-id information is obtained from a caller-id database that is remotely located with respect to the switching office.

21. The apparatus of claim 12, wherein the apparatus is part of a communications device local to the called party.

22. The apparatus of claim 12, wherein the caller-id information includes one or more of a calling party's communication device address, a name of the calling party, a calling party's mailing address, a calling party's electronic mail address, a calling party's facsimile number, a geographical location of the calling party, business category yellow pages information for the calling party, a birthday date of the calling party, and an anniversary d ate of the calling party.

23. A computer program product in a computer readable medium for generating a directory entry for a calling party in a personal directory associated with a called party, comprising: first instructions for obtaining caller-id information for a calling party associated with a calling device in response to receiving a call from the calling device; and
second instructions for adding the caller-id information to the personal directory of the called party.

24. The compute program product of claim 23, further comprising:
third instructions for providing a portion of the caller-id information to a user of a called device; and
fourth instructions for providing a first selectable option for adding the caller-id information to the personal directory of the called party.

25. The computer program product of claim 24, further comprising:
fifth instructions for providing a second selectable option for not adding the caller-id information to the personal directory of the called party; and
sixth instructions for not adding the caller-id information to the personal directory of the called party in response to receiving a selection of the second selectable option.

26. The computer program product of claim 24, further comprising:
fifth instructions for providing a second selectable option for sending the caller-id information to an electronic mail address of the called party; and
sixth instructions for sending the caller-id information to the electronic mail address of the called party in response to receiving a selection of the second selectable option.

27. The computer program product of claim 24, further comprising:
fifth instructions for providing a second selectable option for adding the caller-id information to a call block list; and
sixth instructions for adding the caller-id information to the call block list in response to receiving a selection of the second selectable option.
